(19) United States
(12) Patent Application Publication
(10) Pub. No.: US 2014/0239719 A1
(43) Pub. Date: Aug. 28, 2014

(54) SWITCHED CAPACITOR BASED MULTIPLE OUTPUT FIXED RATIO CONVERTER

(71) Applicant: Pavan Kumar, Portland, OR (US)

(72) Inventor: Pavan Kumar, Portland, OR (US)

(73) Assignee: Intel Corporation, Santa Clara, CA (US)

(21) Appl. No.: 13/996,685

(22) PCT Filed: Dec. 9, 2011
(86) PCT No.: PCT/US11/64155

§ 371 Date: May 8, 2014

(51) Int. Cl. H02M 3/07

(52) U.S. Cl. CPC H02M 3/07
USPC 307/31; 323/364

(57) ABSTRACT

Systems and methods of generating output multiple voltages may include connecting a first low pass filter to a switched capacitor voltage divider at the first junction point. The switched capacitor voltage divider may be configured to receive an input voltage and to generate a first output voltage. The first low pass filter may be associated with a second output voltage. The first junction point may be positioned between a first switch and a second switch of the switched capacitor voltage divider.

### BACKGROUND

1. Technical Field

Embodiments generally relate to power delivery. More particularly, embodiments relate to delivering multiple voltages at low platform cost.

2. Discussion

Most computing platforms may employ multiple Voltage Regulator (VR) implementations to deliver a myriad of output voltages to power silicon loads (e.g., processing units, chipsets, memory, etc). Each of these loads may be powered by individual VR's. The high number of VRs may result in higher cost, require more space and generate large power conversion losses.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1A is a block diagram that illustrates an example of a conventional approach of generating a output voltage;

FIG. 1B is a circuit diagram of a switched capacitor based Triple Output Fixed Ratio Converter (TOFRC), according to an embodiment;

FIGS. 2-5 include circuit diagrams and timing diagram associated with an example operation of the Triple Output Fixed Ratio Converter, according to an embodiment;

FIG. 6 is a circuit diagram showing an example current flow during a first time interval, according to an embodiment;

FIG. 7 is a circuit diagram showing an example current flow during a second time interval, according to an embodiment;

FIG. 8 is a block diagram showing an example application of the Triple Output Fixed Ratio Converter, according to an embodiment;

FIGS. 9A and 9B are circuit diagrams showing examples of using a switched capacitor voltage divider to generate additional output voltages, according to an embodiment;

FIG. 10 is a circuit diagram showing an example of a ladder network that may be used to generate multiple output voltages based on the same principle of the earlier instantiation of the Triple Output Fixed Ratio Converter, according to an embodiment;

FIG. 11 is a flowchart of an example method of using a switched capacitor voltage divider to generate multiple output voltages, according to an embodiment; and

FIG. 12 is a block diagram showing an example computer system having electronic components that may be implemented using the multiple output fixed ratio converter, according to an embodiment.

### DETAILED DESCRIPTION

Embodiments may involve an apparatus which includes a switched capacitor voltage divider configured to generate a first output voltage. The switched capacitor voltage divider may be associated with an input voltage. A first low pass filter (or pair of inductor and capacitor) may be coupled to the switched capacitor voltage divider at a first junction point. The first low pass filter may be associated with a second output voltage.

Embodiments may involve an apparatus which includes a voltage divider configured to generate a first output voltage and a second output voltage. The voltage divider associated with an input voltage. A first low pass filter may be coupled to the voltage divider at a first junction point. The first low pass filter may be associated with a third output voltage. A second low pass filter may be coupled to the voltage divider at a second junction point. The second low pass filter may be associated with a fourth output voltage. A third low pass filter may be coupled to the voltage divider at third junction point. The third low pass filter may be associated with a fifth output voltage.

Embodiments may involve a computer system which includes a bus, a power supply coupled to the bus, and a clock generator coupled to the bus. The system may further include a voltage divider coupled to the power supply and the clock generator. The voltage divider may be configured to receive an input voltage from the power supply and to generate a first output voltage. The voltage divider may be coupled to a first low pass filter at a first junction point to generate a second output voltage.

Embodiments may involve a computer implemented method which includes connecting a first low pass filter to a switched capacitor voltage divider at the first junction point. The switched capacitor voltage divider may be configured to receive an input voltage and to generate a first output voltage. The first low pass filter may be associated with a second output voltage. The first junction point may be positioned between a first switch and a second switch of the switched capacitor voltage divider.

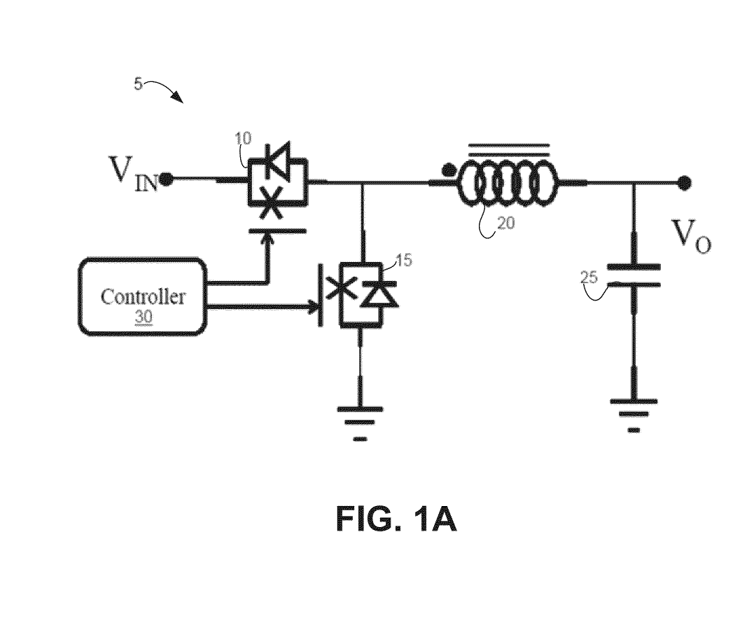

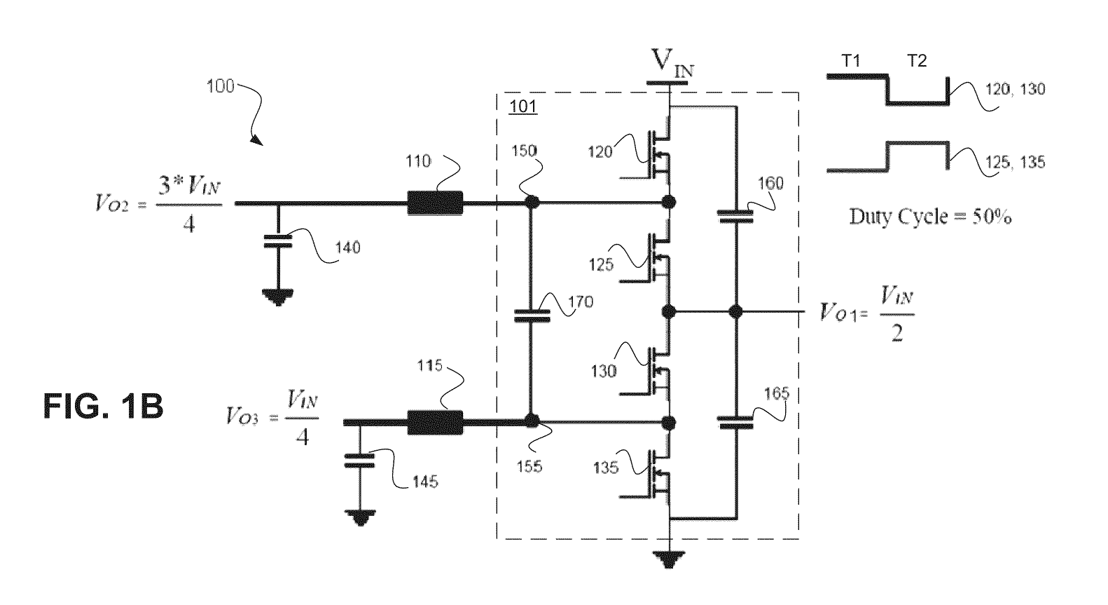

Turning to FIG. 1A, a circuit diagram 5 of a conventional approach used to generate an output voltage is shown. The circuit diagram 5 may also be referred to as a buck converter, and it may be used as a step-down DC to DC converter. The buck converter may use two field-effect transistors (FETs) 10 and 15, an output inductor 20 and a filter capacitor 25 along with a controller 30. It may be noted that FET drivers (not shown) may be included in the controller 30. The output inductor 20 may be connected to the source voltage V_{I}. The two FETs 10 and 15 may control the output inductor 20 such that energy may be stored in the output inductor 20, or it may be may be discharged into the load Vo. As can be seen, five (5) components 10, 15, 20, 25 and 30 may be needed to deliver an output voltage. To generate three (3) output voltages, about 15 components may be needed. This may result in large area requirement and higher cost.

Turning to FIG. 1B, a circuit diagram 100 of a switched capacitor based Triple Output Fixed Ratio Converter (TOFRC) 100 is shown. The phrase “Fixed Ratio Converter” is used to indicate that the output voltage V_{OUT} at any given point in the circuit diagram 100 may be a fixed ratio (e.g., 2:1) of the input voltage V_{IN}, and the output voltage V_{OUT} may not change with variation in the duty cycle under steady state conditions. A duty cycle may be defined as a ratio of a time that a switch (or a pair of switches) is set to an ON state over a total switching period. The circuit diagram 100 may be used to generate multiple output voltages with a single power conversion topology while using fewer components than the conventional approach.

The circuit diagram 100 may include a switched capacitor voltage divider 101, which may include four (4) switches 120, 125, 130, 135 and three (3) capacitors 160, 165 and 170. The switched capacitor voltage divider 101 may also include two junction points 150 and 155. It may be noted that the junction point 150 is positioned between the first switch 120 and the second switch 125, and the junction point 155 is positioned between the third switch 130 and the fourth switch 135. The voltage at each of the three capacitors 160, 165 and 170 may be derived based on the following formula:

V_{C160}=V_{C165}=V_{C170}=V_{IN}/2

The circuit diagram 100 may include two (2) inductors 110 and 115 and two (2) capacitors 140 and 145. The capacitor 140 may be associated with the inductor 110 and may be connected to a ground terminal. The capacitor 145 may be associated with the inductor 115 and may also be connected to the ground terminal. The input voltage of the circuit diagram 100 may be illustrated as V_{IN}, and the three output voltages of the circuit diagram 100 may be illustrated as V_{O1}, V_{O2} and V_{O3}. It may be noted that the output voltage V_{O1} may be associated with the switched capacitor voltage divider 101.

The switches 120 and 130 may be operated in a synchronous fashion (e.g., they may be turned ON or OFF at the same time). The switches 125 and 135 may be operated in a complementary fashion with respect to the switches 120 and 130. For example, when the switches 120 and 130 are set to ON, the switches 125 and 135 may be set to OFF. The complementary operations of the pair of switches 120, 130 and 125, 135 may generate an output voltage equal to one half of the supply voltage V_{IN} to be available at the output V_{O1} (or V_{O1}=V_{IN}/2).

It may be noted that the voltage at the junction point 155 in reference to a ground terminal may vary between V_{IN}/2 and zero with a duty cycle of about one half (or 50%). The average value of the voltage at the junction point 155 may therefore be equal to V_{IN}/4, When a low pass filter consisting of the inductor 115 and the capacitor 145 is connected to the junction point 155, an additional output voltage of V_{IN}/4 may be obtained. This additional voltage is shown as V_{O3} in the circuit diagram 100. The following formula may represent how the average voltage V₀₃ may be derived:

V_{O3}=¼ V_{IN}=0.25*V_{IN}.

Similarly, it may be noted that the voltage at the junction point 150 may vary between V_{IN} and V_{IN}/2 with a duty cycle of about one half (or 50%). The average value of the voltage at the junction point 150 may therefore be equal to (¾)*V_{IN}. When a low pass filter consisting of the inductor 110 and the capacitor 140 is connected to the junction point 150, an additional output voltage ¾ V_{IN} may be obtained. This additional voltage is shown as V_{O2} in the circuit diagram 100. The following formula may represent how the average voltage V₀₂ may be derived:

V_{O2}=¾ V_{IN}=0.75*V_{IN}.

Thus, using the circuit diagram 100, three (3) different output voltages (or voltage rails) V_{O1}, V_{O2} and V_{O3} may be derived based on the same input voltage V_{IN}. This is why the circuit diagram 100 may be referred to as a Triple Output Fixed Ratio Converter. It may be noted that the secondary outputs V_{O2} and V_{O3} may act as typical buck converter outputs, and the primary output V_{O1} may be a result of the switched capacitor based divider 101.

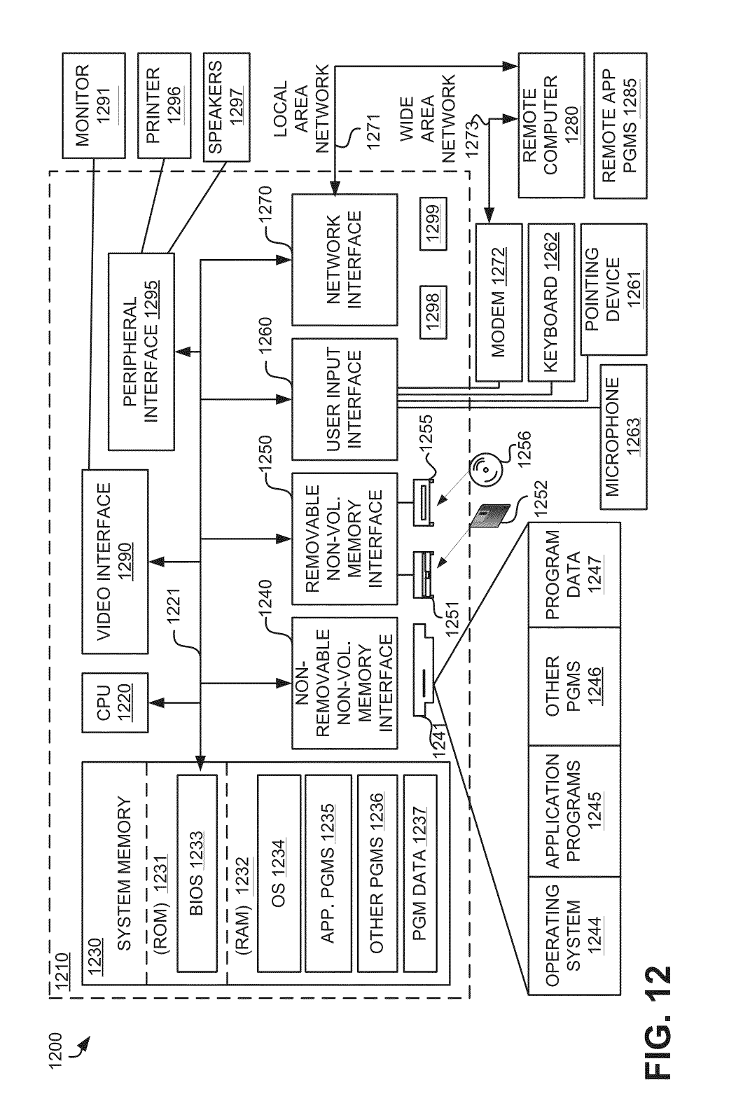

The circuit diagram 100 may be used to deliver multiple supply voltages to various subsystems within a computer system. For example, the various subsystems may include a central processing unit (CPU), memory, input/output control hubs (or chipsets), graphics, audio, local area network (LAN), etc. The subsystems may operate at different power supply voltage levels. The input voltage V_{IN} may be associated with a power supply of the computer system, and the operations of the components in the circuit diagram 100 may be based on clock signals generated by a clock generator of the computer system. A diagram of an example computer system is shown in FIG. 12.

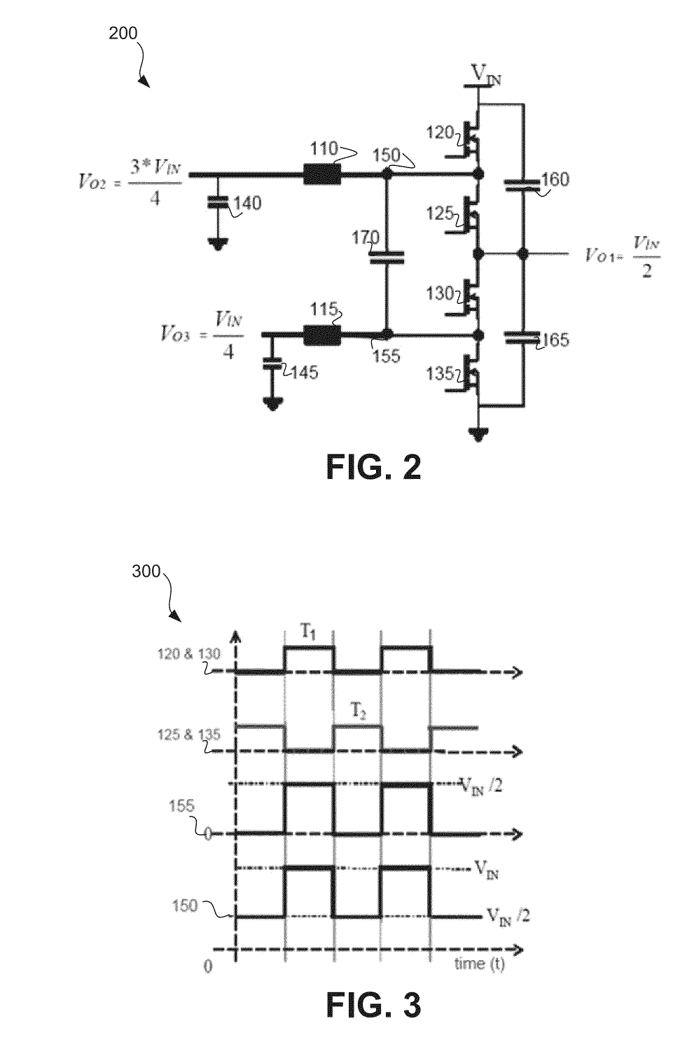

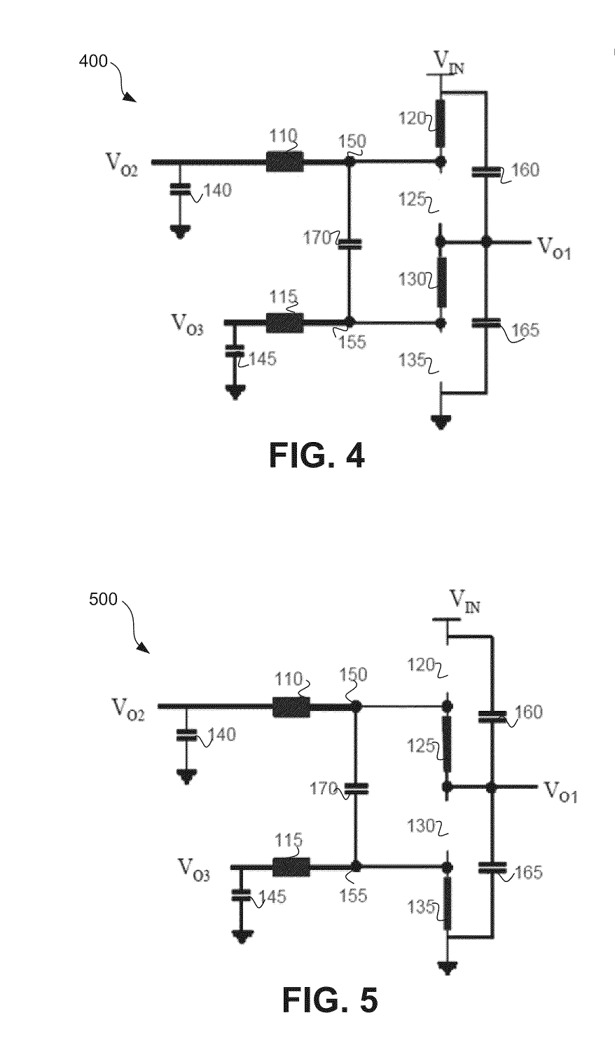

An example of the operation of the switched capacitor based Triple Output Fixed Ratio Converter is shown in FIGS. 2-5. FIG. 2 includes a circuit diagram 200 that is similar to the circuit diagram 100 of FIG. 1B. FIG. 3 includes a timing diagram 300 that shows the states of the switches 120, 125, 130 and 135 at different time intervals. The horizontal axis of the timing diagram 300 may show the elapsed time, while the vertical axis of the timing diagram 300 may show the behavior of the switches 120, 125, 130, and 135 and at the junction points 155 and 155 with respect to the elapsed time. FIG. 4 includes an equivalent circuit diagram 400 that shows the states of the switches 120, 125, 130 and 135 during a first time interval (e.g., T1), FIG. 5 includes an equivalent circuit diagram 500 that shows the states of the switches 120, 125, 130 and 135 during a second time interval (e.g., T2).

Turning to the timing diagram 300 of FIG. 3, during the time interval T1, the switches 120 and 130 may be configured to be in the ON state, and the switches 125 and 135 may be configured to be in the OFF state. The states of the switches 120, 125, 130 and 135 during the time interval T1 may be shown in the equivalent circuit diagram 400 of FIG. 4. Also during the time interval T1, the voltage at the junction point 150 may be equal to V_{IN}, while the voltage at the junction point 155 may be equal to V_{O1}, which may be equal to V_{IN}/2. This may be true under all steady state conditions. Under the steady state conditions, the three capacitors 160, 165 and 170 may all be charged equally to V_{IN}/2. The time interval T1 may be associated with a charge phase.

During the time interval T2, the switches 125 and 133 may be configured to be in the ON state, and the switches 120 and 130 may be configured to be in the OFF state. The states of the switches 120, 125, 130 and 135 during the time interval T2 may be shown in the equivalent circuit diagram 500 of FIG. 5. The duty cycle used may be about 50% for the switching. During the time interval T2, the junction point 150 may be connected to the output V_{O1} which may be equal to V_{IN}/2 via the switch 125, while the junction point 155 may be connected to the ground terminal via the switch 135.

The combination of the inductor 110 and the capacitor 140 may act as a low pass filter at the junction point 150 resulting in the output voltage V_{O2}, which may be equal to ¼ V_{IN}. Similarly, the combination of the inductor 115 and the capacitor 145 may act as a low pass filter at the junction point 155 resulting in the output voltage V_{O3}, which may be equal to ¼ V_{IN}. The time interval T2 may be associated with a discharge phase. A combination of the time intervals T1 and T2 may be referred to as a period or a cycle, with each of the time intervals T1 and 12 covering half a period or cycle.

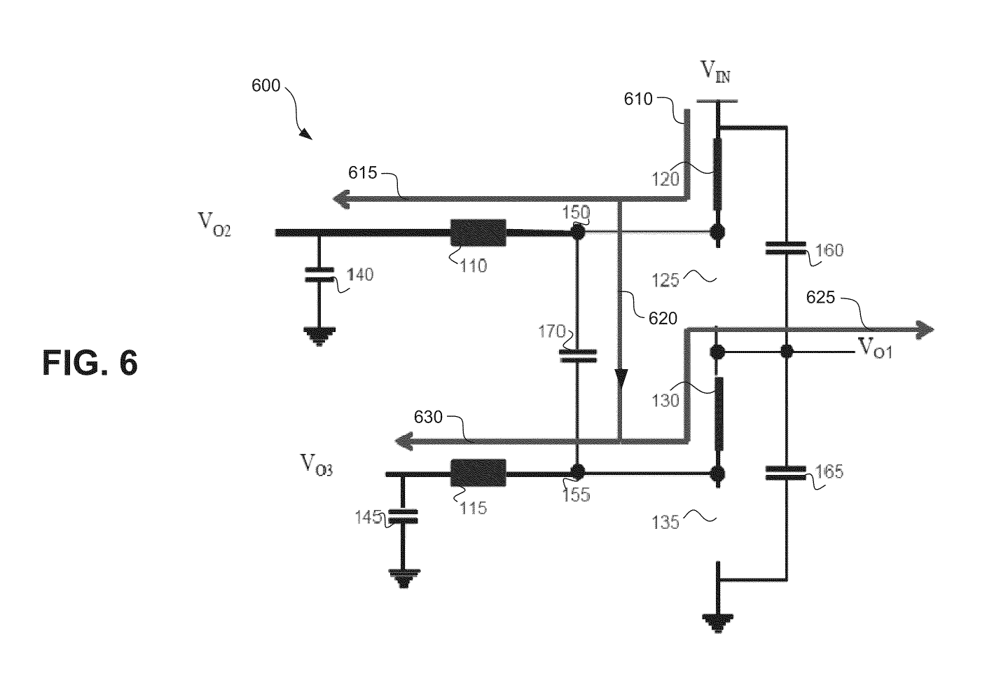

Turning to FIG. 6, a circuit diagram showing current flow during the time interval T1 is shown. When the switches 120, 130 are configured to be in the ON state, and the switches 125, 135 are configured to be in the OFF state, the current may flow along a first path in a direction from the switch 120 to the inductor 110 (from point 610 to point 615), along a second path in a direction from the switch 120 to the capacitor 170 and to the inductor 115 (from point 610 to point 620 and then point 630), and along a third path in a direction from the switch 120 to the capacitor 170 and to the switch 130 (from point 610 to point 620 and then point 625). Each of the three paths during the time interval T1 may be identified by arrows pointing in the direction of the current flow. It may be noted that during the time interval T1, the capacitors 160 and 1170 may be charged, and the capacitor 165 may be discharging.

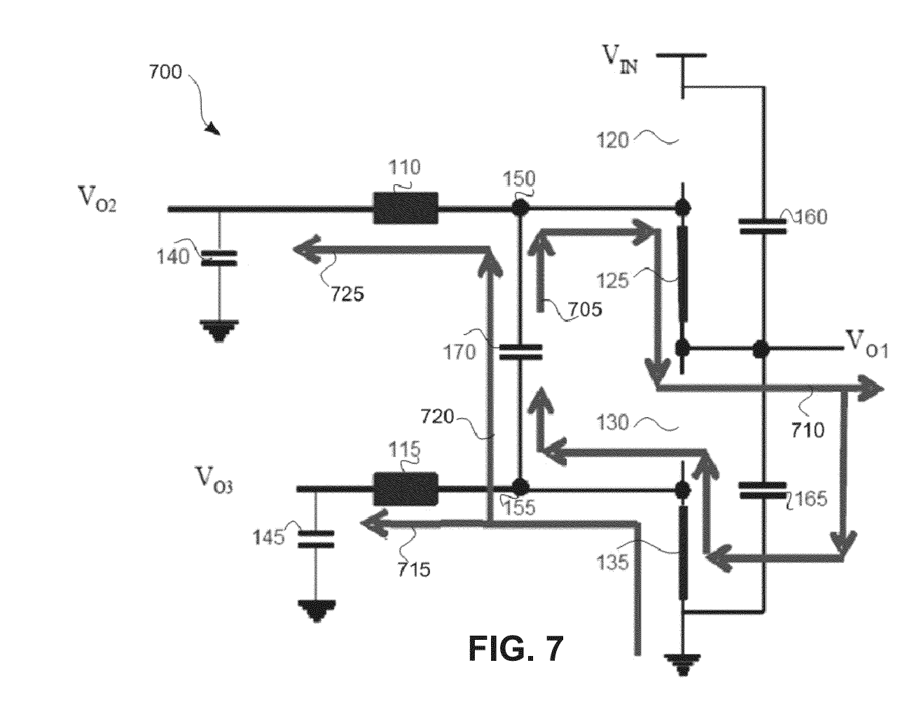

Turning to FIG. 7, a circuit diagram showing current flow during the time interval T2 is shown. When the switches 120, 130 are configured to be in the OFF state, there may be no current flowing through the switch 120 because it is in the OFF state. As a result, the current that may flow through the circuit diagram 700 may be based on the discharging of the capacitors 160 and 170. During the time interval T2, the capacitor 165 may be charged. The current may flow along a first path in a direction from the capacitor 170 to the switch 125 (from point 705 to point 710), along a second path in a direction from the capacitor 170 to the switch 125, the capacitor 165, and the inductor 115 (from point 705 to point 710 and then to point 715), and along a third path in a direction from the capacitor 170 to the inductor 110 (from point 720 to point 725). Each of the three paths during the time interval T2 may be identified by arrows pointing in the direction of the current flow. It may be noted that the condition of the output voltages V_{O1}, V_{O2} and V_{O3} and current flows may be as described when the duty cycle is maintained at about one half (or 50%).

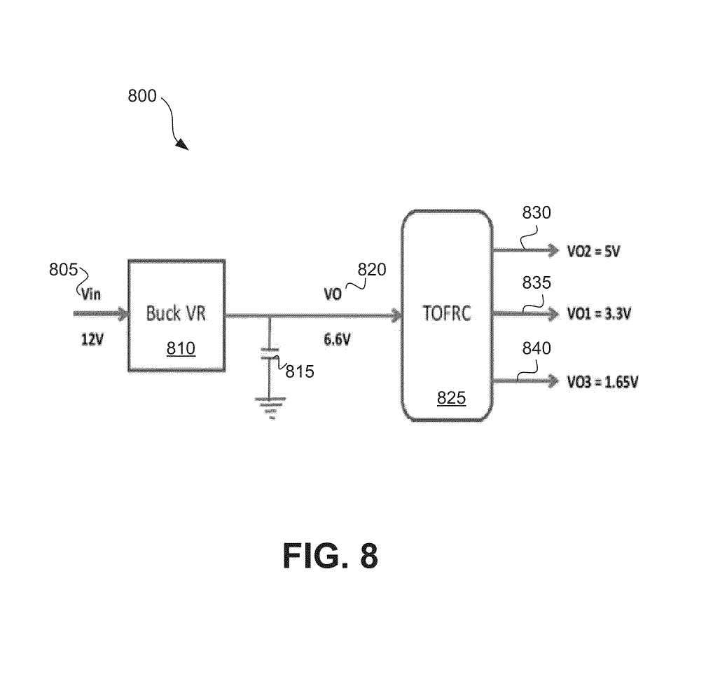

Turning to FIG. 8, a block diagram 800 of an example application of the Triple Output Fixed Ratio Converter is shown. The diagram 800 may include a buck converter 810, a capacitor 815 and a Triple Output Fixed Ratio Converter 825. The Triple Output Fixed Ratio Converter 825 may be preceded by the regulated buck converter 810 that may generate an output voltage V_{O} 820 of 6.6V from a power supply input voltage V_{IN} 805 of 12V. The Triple Output Fixed Ratio Converter 825 may then be used to generate three typical platform voltages V_{O2} 830 of 5V, V_{O1} 835 of 3.3V, and V_{O3} 840 of 1.65V.

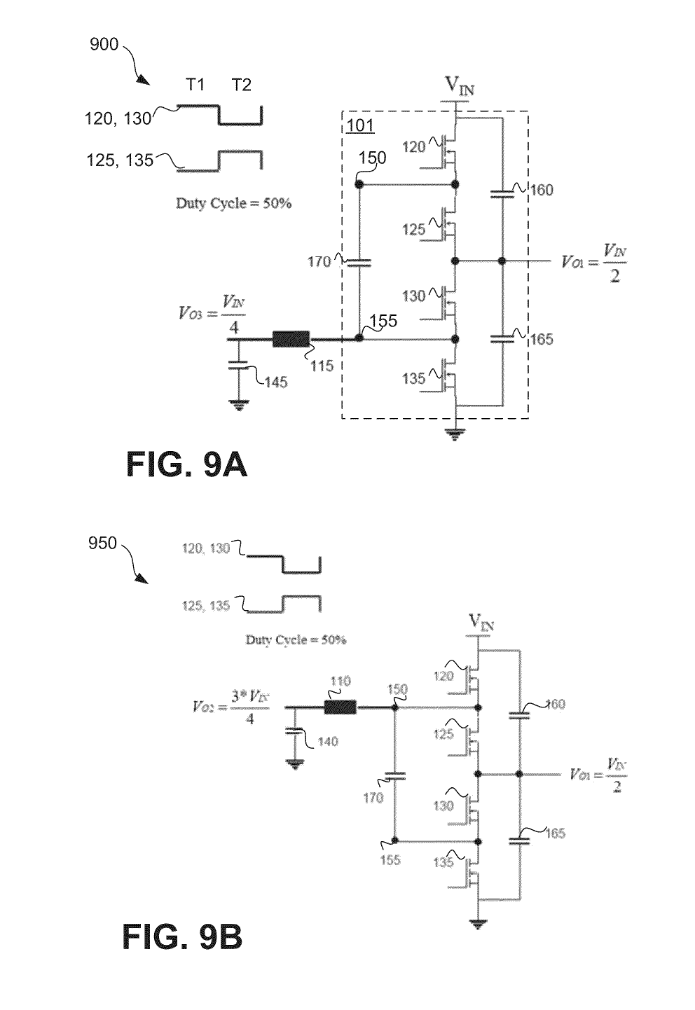

Turning to FIG. 9A, a circuit diagram 900 that may include the switched capacitor divider 101 of FIG. 1B and a pair of inductor and capacitor is shown. The circuit diagram 800 may be similar to the circuit diagram 100 of FIG. 1B except that there is only one pair of inductor 115 and capacitor 145. In this example, the inductor 115 and the capacitor 145 may be connected to the junction point 155 resulting in the output voltage V_{O3} of ¼ V_{IN}. FIG. 9B shows a circuit diagram 950 that may include the switched capacitor divider 101 of FIG. 1B and the pair of inductor 110 and capacitor 140 connected to the junction point 150 resulting in the output voltage V_{O2} of ¾ V_{IN}. The circuit diagrams 900 and 950 may be used to show that it may be possible to have only two output voltages V_{O1} and V_{O3} or V_{O1} and V_{O2} using seven (7) components instead of eight (8) components based on the conventional approach.

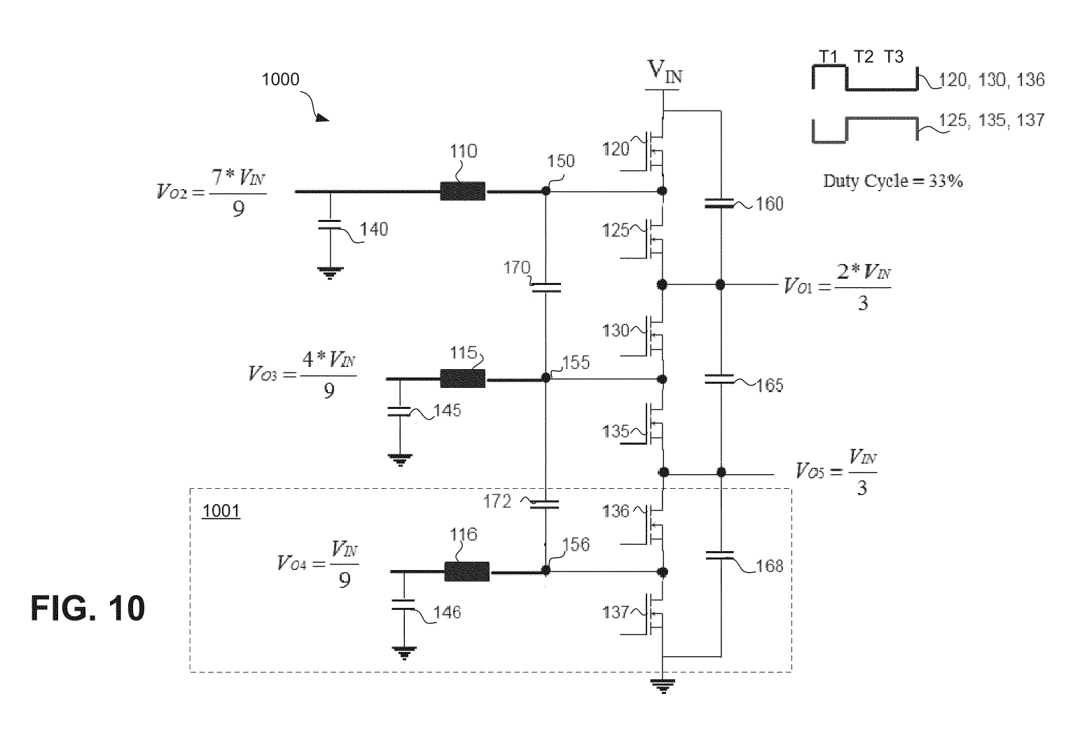

Turning to FIG. 10, a circuit diagram 1000 that includes a stacked configuration of a switched capacitor network is shown. The circuit diagram 1000 may include the circuit diagram 100 of FIG. 1B connected to a circuit diagram 1001 (shown in the dotted block 1001). The circuit diagram 1000 may be used to generate five (5) different output voltages using fewer components than the conventional approach. The circuit diagram 1000 may include six (6) switches 120, 125, 130, 135, 136, 137 and five (5) capacitors 160, 165, 168, 170 and 172. There may be three junction points 150, 155 and 156. The junction point 150 may be positioned between the first switch 120 and the second switch 125; the junction point 155 may be positioned between the third switch 130 and the fourth switch 135; and the junction 156 may be positioned between the fifth switch 136 and the sixth switch 137.

The circuit diagram 1000 may include three (3) pair of inductors and capacitors: 110 and 140, 115 and 145, and 116 and 146. The capacitors 140, 145 and 146 are connected to the ground terminal. The input voltage of the circuit diagram 1000 is shown as V_{IN}, and the five output voltages of the circuit diagram 1000 may be shown as V_{O1}, V_{O2}, V_{O3}, V_{O4} and V_{O5}. The switches 120, 130 and 136 may be operated in a synchronous fashion (e.g., they may be turned ON or OFF at the same time). The switches 125, 135 and 137 may be operated in a complementary fashion with respect to the switches 120, 130 and 136. For example, when the switches 120, 130 and 136 are set to ON, the switches 125, 135 and 137 may be set to OFF.

The switches 120, 130 and 136 may be configured to operate at about one third (or 33%) duty cycle with the total switching period that comprises T1, T2 and T3. For example, during the time period T1, the switches 120, 130 and 136 may be set to the ON state while the switches 125, 135 and 137 may be set to the OFF state. During the time period T2 and T3, the switches 120, 130 and 136 may be set to the OFF state while the switches 125, 135 and 137 may be set to the ON state (or two third duty cycle). The complementary operations of the two groups of switches 120, 130, 136 and 125, 135, 137 may generate an output voltage V_{O1}=⅔ V_{IN} and V_{O5}=⅓ V_{IN}.

When a low pass filter consisting of the inductor 115 and the capacitor 145 is connected to the junction point 155 of the circuit diagram 1000, an additional output voltage of 4/9 V_{IN} may be obtained. This additional voltage is shown as V_{O3} in the circuit diagram 1000. The following formula may represent how the average voltage V_{O3} may be derived:

V_{O3}= 4/9 V_{IN}.

When a low pass filter consisting of the inductor 110 and the capacitor 140 is connected to the junction point 150 of the circuit diagram 1000, an additional output voltage 7/9 V_{IN} may be obtained. This additional voltage is shown as V_{O2} in the circuit diagram 1000. The following formula may represent how the average voltage V_{O2} may be derived:

V_{O2}= 7/9 V_{IN}.

When a low pass filter consisting of the inductor 116 and the capacitor 146 is connected to the junction point 156 of the circuit diagram 1000, an additional output voltage 1/9 V_{IN} may be obtained. This additional voltage is shown as V_{O4} in the circuit diagram 1000. The following formula may represent how the average voltage V_{O4} may be derived:

V_{O4}= 1/9 V_{IN}.

Thus, using the circuit diagram 1000, five (5) different output voltages (or voltage rails) V_{O1}, V_{O2}, V_{O3}, V_{O4} and V_{O5} may be derived based on the same input voltage V_{IN}. It may be noted that the circuit diagram 1000 may be extended further to provide even more output voltages using the same technique.

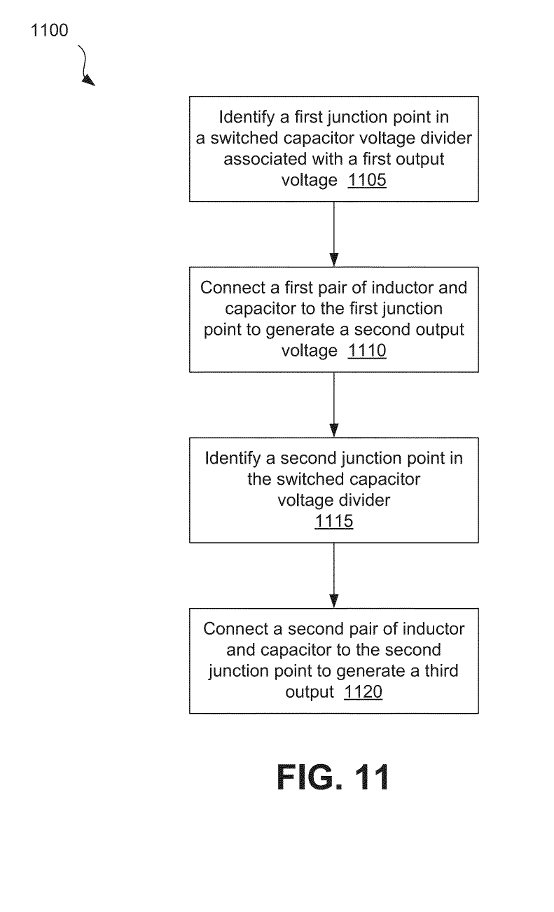

Turning now to FIG. 11, a method 1100 of generating additional output voltages based on a switched capacitor voltage divider in accordance with an embodiment of the present invention is shown. The method may be implemented as a set of logic instructions stored in a machine- or computer-readable storage medium such as RAM (random access memory), ROM (read only memory), PROM (programmable ROM), flash memory, etc., in configurable logic such as PLAs (programmable logic arrays), FPGAs (field programmable gate arrays), CPLDs (complex programmable logic devices), in fixed-functionality logic hardware using circuit technology such as ASIC (application specific integrated circuit), CMOS (complementary metal oxide semiconductor) or TTL (transistor-transistor logic) technology, or any combination thereof. For example, computer program code to carry out operations shown in the method may be written in any combination of one or more programming languages, including an object oriented programming language such as C++ or the like and conventional procedural programming languages, such as the “C” programming language or similar programming languages.

The method 1100 may be based on using a switched capacitor voltage divider 101 of FIG. 1B having an input voltage, four switches, three capacitors and an output voltage. The method may start at block 1105 where a first junction point in the switched capacitor voltage divider may be identified. This first junction point may correspond to the junction point 150 of FIG. 1B. The switched capacitor voltage divider may be associated with a first output voltage.

At block 1110, a pair of inductor and capacitor may be connected to the first junction point to generate a second output voltage. This pair of inductor and capacitor may correspond to the inductor 110 and the capacitor 140 of FIG. 1B.

At block 1115, a second junction point in the switched capacitor voltage divider may be identified. This second junction point may correspond to the junction point 155 of FIG. 1B.

At block 1120, another pair of inductor and capacitor may be connected to the second junction point to generate a third output voltage. This pair of inductor and capacitor may correspond to the inductor 115 and the capacitor 145 of FIG. 1B. It may be noted that the method 1100 may be modified to enable the connection of only one pair of inductor and capacitor to generate only the output voltage VO2 or VO3 as shown in the circuit diagram 900 of FIG. 9. Similarly, the method 1100 may be modified to enable the connection of multiple pairs of inductor and capacitor to generate multiple output voltages as shown in the circuit diagram 1000 of FIG. 10.

Turning to FIG. 12, a block diagram 1200 of a computer system 1210 and other examples peripherals and input/output devices are shown. The computer system 1210 may include many electronic components that may be configured to operate using voltages supplied by one of the example circuits shown in FIG. 1B-FIG. 10. The computer system 1210 may be configured to operate as a mobile computer system, a desktop computer system, a server computer system, or any other computer systems that may be able to take advantage of the features of the example circuit diagrams shown in FIG. 1B-FIG. 10.

The computer system 1210 may include, but is not limited to, a processing unit (or CPU) 1220 having one or more processing cores, a system memory 1230, and a system bus 1221 that couples various system components including the system memory 1230 to the processing unit 1220. The system bus 1221 may be any of several types of bus structures including a memory bus or memory controller, a peripheral bus, and a local bus using any of a variety of bus architectures. By way of example, and not limitation, such architectures include Industry Standard Architecture (ISA) bus. Micro Channel Architecture (MCA) bus, Enhanced ISA (EISA) bus, Video Electronics Standards Association (VESA) locale bus, and Peripheral Component Interconnect (PCI) bus also known as Mezzanine bus.

The computer system 1210 may include a variety of computer readable media. Computer readable media can be any available media that can be accessed by computer system 1210 and includes both volatile and nonvolatile media, removable and non-removable media. By way of example, and not limitation, computer readable media may store information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer system 1210. Communication media typically embodies computer readable instructions, data structures, or program modules.

The system memory 1230 may include computer storage media in the form of volatile and/or nonvolatile memory such as read only memory (ROM) 1231 and random access memory (RAM) 1232. A basic input/output system (BIOS) 1233, containing the basic routines that help to transfer information between elements within computer system 1210, such as during start-up, may be stored in ROM 1231. The RAM 1232 may contain data and/or program modules that are immediately accessible to and/or presently being operated on by processing unit 1220. By way of example, and not limitation, FIG. 12 illustrates operating system 1234, application programs 1235, other program modules 1236, and program data 1237.

The computer system 1210 may also include other removable/non-removable volatile/nonvolatile computer storage media. By way of example only, FIG. 12 illustrates a hard disk drive 1241 that reads from or writes to non-removable, nonvolatile magnetic media, a magnetic disk drive 1251 that reads from or writes to a removable, nonvolatile magnetic disk 1252, and an optical disk drive 1255 that reads from or writes to a removable, nonvolatile optical disk 1256 such as a CD ROM or other optical media. Other removable/non-removable, volatile/nonvolatile computer storage media. that can be used in the exemplary operating environment include, but are not limited to, USB drives and devices, magnetic tape cassettes, flash memory cards, digital versatile disks, digital video tape, solid state RAM, solid state ROM, and the like. The hard disk drive 1241 may be connected to the system bus 1221 through a non-removable memory interface such as interface 1240, and magnetic disk drive 1251 and optical disk drive 1255 may be connected to the system bus 1221 by a removable memory interface, such as interface 1250.

The drives and their associated computer storage media discussed above and illustrated in FIG. 12, may provide storage of computer readable instructions, data structures, program modules and other data for the computer system 1210. In FIG. 12, for example, the hard disk drive 1241 is illustrated as storing operating system 1244, application programs 1245, other program modules 1246, and program data 1247. Note that these components can either be the same as or different from operating system 1234, application programs 1235, other program modules 1236, and program data 1237. The operating system 1244, the application programs 1245, the other program modules 1246, and the program data 1247 are given different numeric identification here to illustrate that, at a minimum, they may be different copies.

A user may enter commands and information into the computer system 1210 through input devices such as a keyboard 1262, a microphone 1263, and a pointing device 1261, such as a mouse, trackball or touch pad or touch screen. Other input devices (not shown) may include a joystick, game pad, scanner, or the like. These and other input devices may be connected to the processing unit 1220 through a user input interface 1260 that may be coupled to the system bus 1221, but may be connected by other interface and bus structures, such as a parallel port, game port or a universal serial bus (USB). A monitor 1291 or other type of display device may be connected to the system bus 1221 via an interface, such as a video interface 1290. In addition to the monitor, the computer system 1210 may also include other peripheral output devices such as speakers 1297 and printer 1296, which may be connected through an output peripheral interface 1295.

The computer system 1210 may operate in a networked environment using logical connections to one or more remote computers, such as a remote computer 1280. The remote computer 1280 may be a personal computer, a hand-held device, a server, a router, a network PC, a peer device or other common network node, and typically includes many or all of the elements described above relative to the computer system 1210. The logical connections depicted in FIG. 12 may include a local area network (LAN) 1271 and a wide area network (WAN) 1273, but may also include other networks. Such networking environments are commonplace in offices, enterprise-wide computer networks, intranets and the Internet.

When used in a LAN networking environment, the computer system 1210 may be connected to the LAN 1271 through a network interface or adapter 1270. When used in a WAN networking environment, the computer system 1210 may include a modem 1272 or other means for establishing communications over the WAN 1273, such as the Internet. The modem 1272, which may be internal or external, may be connected to the system bus 1221 via the user-input interface 1260, or other appropriate mechanism. In a networked environment, program modules depicted relative to the computer system 1210, or portions thereof, may be stored in a remote memory storage device. By way of example, and not limitation, FIG. 12 illustrates remote application programs 1285 as residing on remote computer 1280. It will be appreciated that the network connections shown are exemplary and other means of establishing a communications link between the computers may be used.

It should be noted that some embodiments of the present invention may be carried out on a computer system such as that described with respect to FIG. 12. However, some embodiments of the present invention may be carried out on a server, a computer devoted to message handling, handheld devices, or on a distributed system in which different portions of the present design may be carried out on different parts of the distributed computing system.

Another device that may be coupled to the system bus 1221 is a power supply 1298 such as a battery or a Direct Current (DC) power supply) and Alternating Current (AC) adapter circuit. The DC power supply may be a battery, a fuel cell, or similar DC power source needs to be recharged on a periodic basis. A clock generator 1299 may also be used to provide clock signals. For example, the clock generator 1299 may be associated with a Triple Output Fixed Ratio Converter shown in FIG. 1B to providing timing information to control the operations of the switches 120, 125, 130 and 135. The communication module (or modem) 1272 may employ a Wireless Application Protocol (WAP) to establish a wireless communication channel. The communication module 1272 may implement a wireless networking standard such as Institute of Electrical and Electronics Engineers (IEEE) 802.11 standard, IEEE std. 802.11-1999, published by IEEE in 1999.

Embodiments of the present invention may be applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. might be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A voltage converter apparatus comprising:
a switched capacitor voltage divider configured to generate a first output voltage, the switched capacitor voltage divider associated with an input voltage; and
a first low pass filter coupled to the switched capacitor voltage divider at a first junction point and associated with a second output voltage.

2. The apparatus of claim 1, wherein the switched capacitor voltage divider includes four switches with a first switch and a third switch configured to operate in a complementary manner with a second switch and a fourth switch.

3. The apparatus of claim 2, wherein the first switch and the third switch are configured to operate at about one half duty cycle of a switching period.

4. The apparatus of claim 3, wherein the second switch and the fourth switch are configured to operate at about one half duty cycle of the switching period.

5. The apparatus of claim 4, wherein the first junction point is positioned between the first switch and the second switch, and wherein the first low pass filter includes a capacitor connected to a ground terminal.

6. The apparatus of claim 5, further comprising a second low pass filter coupled to the switched capacitor voltage divider at a second junction point and associated with a third output voltage.

7. The apparatus of claim 6, wherein the second junction point is positioned between the third switch and the fourth switch, and wherein the second low pass filter includes a capacitor connected to the ground terminal.

8. The apparatus of claim 1, wherein each of the first and second low pass filters includes an inductor and a capacitor.

9. An apparatus comprising:
a voltage divider configured to generate a first output voltage and a second output voltage, the voltage divider associated with an input voltage;
a first low pass filter coupled to the voltage divider at a first junction point and associated with a third output voltage;
a second low pass filter coupled to the voltage divider at a second junction point and associated with a fourth output voltage; and
a third low pass filter coupled to the voltage divider at third junction point and associated with a fifth output voltage.

10. The apparatus of claim 9, wherein the voltage divider includes six switches with a first switch, a third switch and a fifth switch configured to operate in a complementary manner with a second switch, a fourth switch and a sixth switch.

11. The apparatus of claim 10, wherein the first switch, the third switch and the fifth switch are configured to operate at about one third duty cycle of a switching period.

12. The apparatus of claim 11, wherein the second switch, the fourth switch and the sixth switch are configured to operate at about two third duty cycle of a switching period.

13. The apparatus of claim 9, wherein a capacitor of the first low pass filter, a capacitor of the second low pass filter, and a capacitor of the third low pass filter are connected to a ground terminal.

14. The apparatus of claim 11, wherein the first junction is positioned between the first switch and the second switch, wherein the second junction point is positioned between the third switch and the fourth switch, and the third junction point is positioned between the fifth switch and the sixth switch.

15. The apparatus of claim 9, wherein each of the first low pass filter, the second low pass filter and the third low pass filter includes a capacitor and an inductor.

16. A system comprising:
a bus;
a power supply coupled to the bus;
a clock generator coupled to the bus; and
a voltage divider coupled to the power supply and the clock generator, the voltage divider configured to receive an input voltage from the power supply and to generate a first output voltage, wherein the voltage divider is coupled to a first low pass titter at a first junction point to generate a second output voltage.

17. The system of claim 16, wherein the voltage divider is coupled to a second low pass filter at a second junction point to generate a third output voltage.

18. The system of claim 17, wherein the voltage divider includes four switches with a first switch and a third switch configured to operate in a complementary manner with a second switch and a fourth switch.

19. The system of claim 18, wherein the first switch and the third switch are configured to operate at about one half duty cycle of a switching period, and wherein the second switch and the fourth switch are configured to operate at about one half duty cycle of the switching period.

20. The system of claim 19, wherein the first junction point is positioned between the first switch and the second switch, wherein the second junction point is positioned between the third switch and the fourth switch, and wherein a capacitor of the first low pass filter and a capacitor of the second low pass filter are connected to a ground terminal.

21. The system of claim 17, wherein the voltage divider is coupled to a third low pass filter at a third junction point to generate a fourth output voltage and a fifth output voltage.

22. The system of claim 21, wherein the voltage divider includes six switches with a first switch, a third switch and a fifth switch configured to operate in a complementary manner with a second switch, a fourth switch and a sixth switch.

23. The system of claim 22, wherein the first switch, the third switch and the fifth switch are configured to operate at about one third duty cycle of a switching period, and wherein the second switch, the fourth switch and the sixth switch are configured to operate at about two third duty cycle of the switching period.

24. The system of claim 23, wherein the first junction point is positioned between the first switch and the second switch, wherein the second junction point is positioned between the third switch and the fourth switch, wherein the third junction point is positioned between the fifth switch and the sixth switch, and wherein a capacitor of the first low pass filter, a capacitor of the second low pass filter, and a capacitor of the third low pass filter are connected to a ground terminal.

25. A computer-implemented method comprising:
connecting a first low pass filter to a switched capacitor voltage divider at the first junction point, the switched capacitor voltage divider configured to receive an input voltage and to generate a first output voltage, the first low pass filter associated with a second output voltage, wherein the first junction point is positioned between a first switch and a second switch of the switched capacitor voltage divider.

26. The method of claim 25, further comprising connecting a second low pass filter to the switched capacitor voltage divider at a second junction point positioned between a third switch and a fourth switch of the switched capacitor voltage divider, the second low pass filter associated with a third output voltage.

27. The method of claim 26, wherein the first switch and the third switch are configured to operate at about one half duty cycle of a switching period, and wherein the second switch and the fourth switch are configured to operate at about one half duty cycle of the switching period.

28. The method of claim 26, further comprising connecting a third low pass filter to the switched capacitor voltage divider at a third junction point positioned between a fifth switch and a sixth switch of the switched capacitor voltage divider, the third low pass filter associated with a fourth output voltage and a fifth output voltage.

29. The method of claim 28, wherein the first switch, the third switch and the fifth switch are configured to operate at about one third duty cycle of a switching period, and wherein the second switch, the fourth switch and the sixth switch are configured to operate at about two third duty cycle of the switching period.
